(19) United States
(12) Patent Application Publication
(10) Pub. No.: US 2018/0158638 A1
(43) Pub. Date: Jun. 7, 2018

(54) Circuit Breaker

(71) Applicant: LSIS CO., LTD., Gyeonggi-do (KR)

(72) Inventor: Jae-Seop KIM, Gyeonggi-do (KR)

(21) Appl. No.: 15/637,346

(22) Filed: Jun. 29, 2017

(30) Foreign Application Priority Data
Dec. 5, 2016 (KR) 10-2016-0164088

(51) Int. Cl. H01H 75/10; H01H 71/02

(52) U.S. Cl. CPC H01H 75/10; H01H 71/0207

(57) ABSTRACT

The present disclosure relates to a circuit breaker. The circuit breaker includes a case having an accommodation space inside, an upper busbar and a lower busbar partially accommodated in an upper portion and a lower portion of the case, respectively, a fixed contact provided in the case and connected to the upper busbar, a movable contact hinge-coupled to the lower busbar and fixed to the case via the first elastic member capable of pivoting in one direction, wherein the movable contact performs a trip operation by being released from the fixed contact, a power transfer part connected to one side of the movable contact to cross each other, and transferring a rotation force to the movable contact, and a trip part arranged under a rear end of the power transfer part and pressing the power transfer part upward when current over a certain amount is applied to the inside.

### CROSS-REFERENCE TO RELATED APPLICATIONS

This application claims the priority of Korean Patent Application No. 10-2016-0164088 filed on Dec. 5, 2016, in the Korean Intellectual Property Office, the disclosure of which is hereby incorporated by reference in its entirety.

### BACKGROUND

### 1. Technical Field

The present disclosure relates to a circuit breaker for interrupting the supply of current by performing a trip operation when current over a certain amount is supplied to the inside thereof.

### 2. Description of the Related Art

In general, a circuit breaker is an electric protection device provided between a power source and a load device to protect the load device and a circuit line from a fault current that may be generated in an electric circuit.

In detail, as illustrated in FIGS. 1 and 2, a conventional circuit breaker 1 may include a fixed contact 10, a movable contact 20 having one lower end connected to a spring 21 and contacted by or released from the fixed contact 10, a latch 30 fixed to one side of the movable contact 20, a power transfer part 40 having one end portion connected to an input device 60 and having a hook formed in a lower portion and supported in contact with the latch 30, and a trip part 50 arranged in a lower portion of the power transfer part 40 and pressing the power transfer part 40 upward when current over a certain amount is supplied.

In this state, when the fixed contact 10 and the movable contact 20 are in contact with each other and current over a certain amount is supplied to the inside of the trip part 50, the trip part 50 moves upward and presses one side surface of the power transfer part 40 upward (that is, an upward direction of upward and downward directions). Accordingly, when the power transfer part 40 performs an upward rotational motion, the hook is detached from the latch 30 to be unlocked, and the movable contact 20 pivots by a restoration force of the spring 21 and is separated from the fixed contact 10.

However, in the conventional circuit breaker 1, since the shape of the latch 30 is complex and the latch 30 is coupled to the movable contact 20 by using a bold 31, a nut 32, and a pin 33, the number of parts increases, and thus an assembly time may increase during manufacturing.

### SUMMARY

It is an object of the present disclosure to address the above-described problems and other problems.

It is another object of the present disclosure to provide a circuit breaker in which the number of parts coupled between a latch and a movable contact is reduced, and thus an assembly time may be reduced.

Objects of the present disclosure are not limited to the above-described objects and other objects and advantages can be appreciated by those skilled in the art from the following descriptions. Further, it will be easily appreciated that the objects and advantages of the present disclosure can be practiced by means recited in the appended claims and a combination thereof.

In accordance with one aspect of the present disclosure, a circuit breaker includes a case having an accommodation space inside, an upper busbar and a lower busbar partially accommodated in an upper portion and a lower portion of the case, respectively, a fixed contact provided in the case and connected to the upper busbar, a movable contact hinge-coupled to the lower busbar and fixed to the case via the first elastic member capable of pivoting in one direction, wherein the movable contact performs a trip operation by being released from the fixed contact, a power transfer part connected to one side of the movable contact to cross each other, and transferring a rotation force to the movable contact, and a trip part arranged under a rear end of the power transfer part and pressing the power transfer part upward when current over a certain amount is applied to the inside.

### BRIEF DESCRIPTION OF DRAWINGS

FIG. 1 is a schematic view of the conventional circuit breaker.

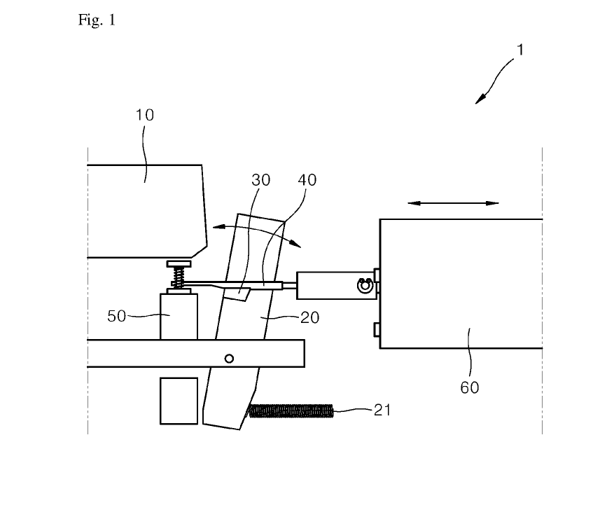

FIG. 2 illustrates the latch of FIG. 1.

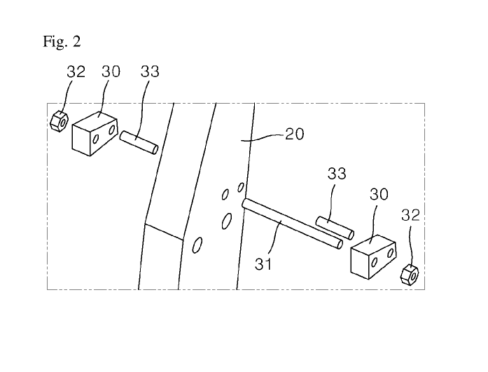

FIG. 3 is an inner side view of a circuit breaker in an ON state, according to an embodiment of the present disclosure.

FIG. 4 is an inner side view of the circuit breaker of FIG. 3 in a TRIP state.

FIG. 5 illustrates a power transfer part of FIG. 4.

FIG. 6 is a cross-sectional view of a circuit breaker in a TRIP state, according to another embodiment of the present disclosure.

### DETAILED DESCRIPTION

The above objects, features and advantages will become apparent from the detailed description with reference to the accompanying drawings. Embodiments are described in sufficient detail to enable those skilled in the art in the art to easily practice the technical idea of the present disclosure. Detailed descriptions of well-known functions or configurations may be omitted in order not to unnecessarily obscure the gist of the present disclosure. Hereinafter, embodiments of the present disclosure will be described in detail with reference to the accompanying drawings. Throughout the drawings, like reference numerals refer to like elements.

As the inventive concept allows for various changes and numerous embodiments, particular embodiments will be illustrated in the drawings and described in detail in the written description, wherein like reference numerals in the drawings denote like elements, and thus their description will not be repeated. The suffix “module” and “unit” for components, which are used in the description below, are assigned and mixed in consideration of only the easiness in writing the specification. That is, the suffix itself does not have different meanings or roles. However, this is not intended to limit the present inventive concept to particular modes of practice, and it is to be appreciated that all changes, equivalents, and substitutes that do not depart from the spirit and technical scope of the present inventive concept are encompassed in the present inventive concept. In the description of the present inventive concept, certain detailed explanations of related art are omitted when it is deemed that they may unnecessarily obscure the essence of the inventive concept.

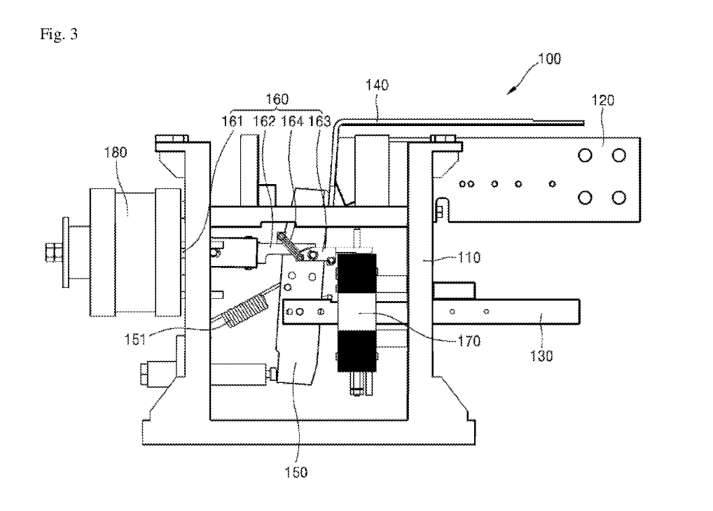

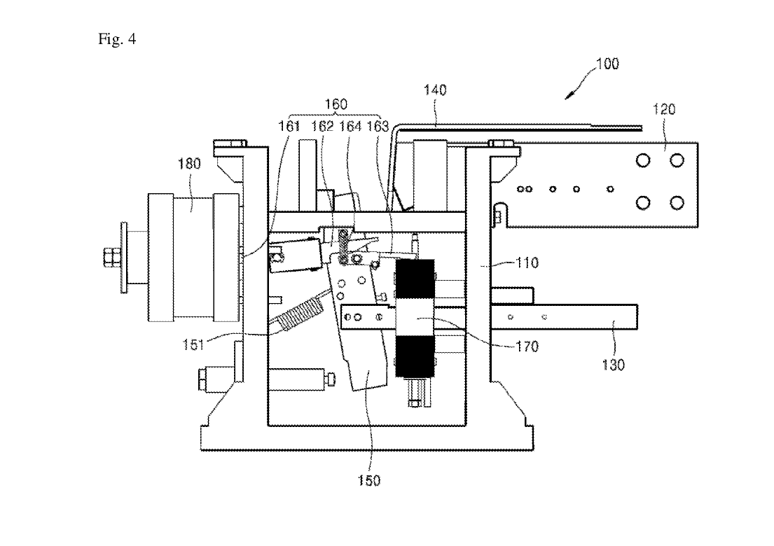

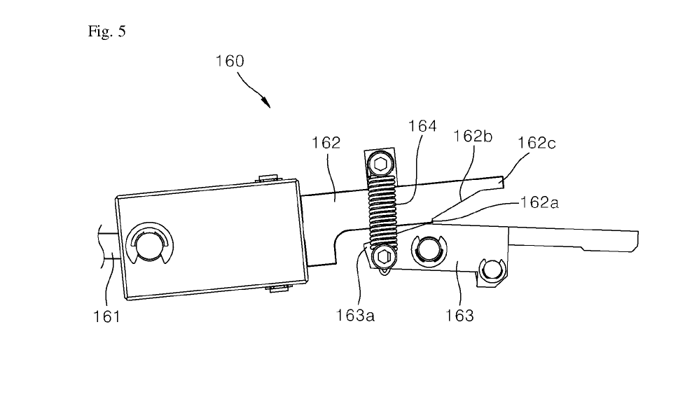

FIG. 3 is an inner side view of a circuit breaker 100 in an ON state, according to an embodiment of the present disclosure. FIG. 4 is an inner side view of the circuit breaker 100 of FIG. 3 in a TRIP state. FIG. 5 illustrates a power transfer part of FIG. 4. As illustrated in FIGS. 3 to 5, the circuit breaker 100, which performs a TRIP operation when a short-circuit or overcurrent occurs, may include a case 110, an upper busbar 120, lower busbar 130, a fixed contact 140, a movable contact 150, a power transfer part 160, and a trip part 170.

The case 110 has an accommodation space inside. A power terminal and a load terminal are installed at one side in the case 110, receive external power, and supply the power toward a load's side.

The upper busbar 120 may be partially accommodated in an upper portion of the case 110. The upper busbar 120 transmits externally applied current and may include a conductive metal material.

The lower busbar 130 may be partially accommodated in a lower portion of the case 110. The lower busbar 130, like the upper busbar 120, transmits current and may include a conductive metal material.

The fixed contact 140 is installed inside the case 110 and connected to the upper busbar 120.

The movable contact 150 is hinge-coupled to the lower busbar 130 and fixed to the case 110 via a first elastic member 151 so as to pivot in one direction.

In detail, a lower portion of one side surface of the movable contact 150 is hinge-coupled to the lower busbar 130, and an upper portion of the other side surface of the movable contact 150 may be connected to the first elastic member 151. In other words, a portion of the movable contact 150 connected to the first elastic member 151 may be located above a portion of the movable contact 150 hinge-coupled to the lower busbar 130.

As the portion coupled to the first elastic member 151 is arranged above the portion hinge-coupled to the lower busbar 130, the movable contact 150 may pivot in one direction during the restoration of the first elastic member 151.

The movable contact 150 performs a TRIP operation by being released from the fixed contact 140.

In other words, as illustrated in FIG. 3, as the fixed contact 140 is connected to the upper busbar 120, when the movable contact 150 contacts the fixed contact 140, a conductive state is established, and thus current may flow toward the load's side. As illustrated in FIG. 4, when the movable contact 150 is released from the fixed contact 140, the flow of current toward the load's side may be prevented.

The power transfer part 160 is connected to one side of the movable contact 150 to cross each other and transfers a rotational force to the movable contact 150. In detail, the power transfer part 160 may include an input load 161, a fork load 162, and a rotating latch 163.

The input load 161 is partially accommodated in the case 110. The input load 161 may be mounted on one end of an input device 180 in a horizontal direction.

A front end of the fork load 162 that is arranged crossing the movable contact 150 is hinge-coupled to the input load 161 capable of pivoting in one direction, and a hook 162a is formed in a lower portion of the fork load 162.

The rotation direction of the fork load 162 may be the same as that of the movable contact 150. In other words, when the movable contact 150 rotates counterclockwise, the fork load 162 also rotates counterclockwise. Reversely, when the movable contact 150 rotates clockwise, the fork load 162 also rotates clockwise.

When an end portion of one side of the rotating latch 163 is coupled to the movable contact 150, one front side of the rotating latch 163 is connected to the fork load 162 via a second elastic member 164, and a catch protrusion 163a caught and supported by the hook 162a is formed in an upper portion thereof.

In detail, the fork load 162 may include a support part 162b, in which a surface contacting the rotating latch 163 is inclined from a front side toward a rear side, and an escape prevention part 162c protruding from an upper side of an inclined surface of the support part 162b toward the rear side. The surface of the rotating latch 163 contacting the fork load 162 may have the same shape as the surface of the fork load 162.

As such, as the hook 162a and the catch protrusion 163a are respectively formed on the fork load 162 and the rotating latch 163, the catch protrusion 163a of the rotating latch 163 is supported on the hook 162a of the fork load 162 and prevented from escaping downward. As an upper surface of the rotating latch 163 is supported on the escape prevention part 162c of the fork load 162 and prevented from escaping upward, the rotating latch 163 may be arranged parallel to the fork load 162.

The trip part 170 is arranged under a rear end of the power transfer part 160. When current over a certain amount is supplied to the inside of the trip part 170, the trip part 170 presses the power transfer part 160 upward, and thus the movable contact 150 contacting the fixed contact 140 pivots in one direction.

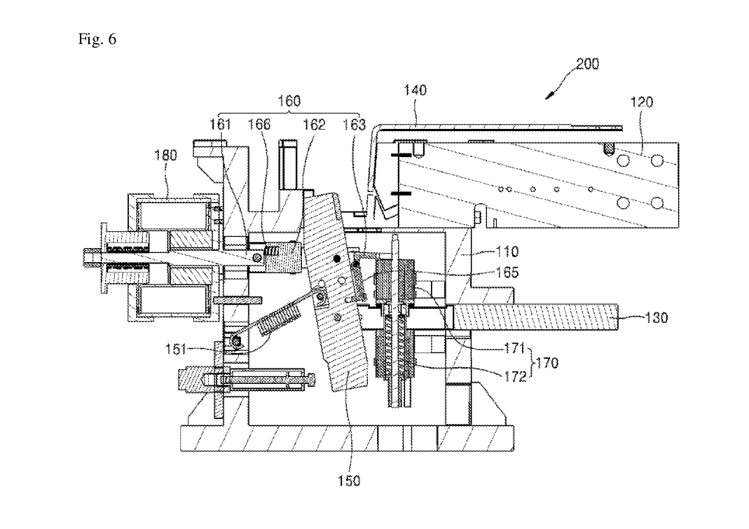

The trip part 170 may include a movable core 171 (see FIG. 6) arranged under the rear end of the power transfer part 160 and pressing the power transfer part 160, and a spring pusher 172 (see FIG. 6) applying a compression force to the movable core 171 downward (that is, a downward direction of upward and downward directions) to prevent the movable core 171 from moving upward and pressing the lower transfer part 160 upward when current supplied to the inside is less than a preset current value. The amount of an elastic force of the spring pusher 172 may be adjusted considering a force pulling the movable core 171 upward by the current in the trip part 170.

Accordingly, when short-circuit or overcurrent over a certain amount is supplied to the trip part 170, the trip part 170 is moved upward. As the trip part 170 moves upward, a part of the rotating latch 163 is pressed upward and pivots in one direction. Then, the fork load 162 contacting the rotating latch 163 also rotates in one direction and moves upward, and thus the catch protrusion 163a supported on the hook 162a of the fork load 162 escapes from the hook 162a. Then, the movable contact 150 pivots in one direction by an electron repulsion force and a restoration force of the first elastic member 151 and is released from the fixed contact 140, and thus the circuit breaker 100 is in a TRIP state, as illustrated in FIG. 4.

As described above, when short-circuit or overcurrent occurs, the circuit breaker 100 separates the fork load 162 and the rotating latch 163 to make the movable contact 150 rapidly released from the fixed contact 140, thereby reducing an interruption time.

In addition, unlike the conventional technology, since a separate coupling member to fix the rotating latch 163 to the fixed contact 140 is not needed, an assembly time may be reduced.

FIG. 6 is a cross-sectional view of a circuit breaker 200 in a TRIP state, according to another embodiment of the present disclosure. In the following description, differences between the above-described embodiment and the present embodiment are mainly discussed.

As illustrated in FIG. 6, the circuit breaker 200 may include the case 110, the upper busbar 120, the lower busbar 130, the fixed contact 140, the movable contact 150, the power transfer part 160, and the trip part 170.

The case 110 has an accommodation space inside.

The upper busbar 120 and the lower busbar 130 are partially accommodated in the upper and lower portions of the case 110, respectively

The fixed contact 140 is provided in the case 110 and connected to the upper busbar 120.

The movable contact 150 has one side surface that is hinge-coupled to the lower busbar 130 and the other side surface that is fixed to the case 110 via the first elastic member 151. Accordingly, the movable contact 150 is capable of pivoting in one direction to be released from the fixed contact 140, thereby performing a trip operation.

The power transfer part 160 is connected to one side of the movable contact 150 to cross each other, and transfers a rotational force to the movable contact 150. In detail, the power transfer part 160 may include the input load 161, the fork load 162, and the rotating latch 163.

The input load 161 is partially accommodated in the case 110. The input load 161 may be provided on one end of the input device 180 in the horizontal direction.

The fork load 162, which is arranged crossing the movable contact 150, may be capable of moving back and forth from the input load 161. The hook 162a may be formed in a lower portion of the fork load 162.

When the end portion of one side of the rotating latch 163 is coupled to the movable contact 150, the rotating latch 163 is connected to a rear one side of the movable contact 150 via a third elastic member 165, and the catch protrusion 163a caught and supported by the hook 162a is formed in the upper portion thereof.

In detail, the fork load 162 may be capable of moving back and forth by means of a fourth elastic member 166 having a front end and a rear end respectively connected to the input load 161 and the fork load 162, and arranged in the horizontal direction.

The fork load 162 may include the support part 162b, in which the surface contacting the rotating latch 163 is inclined from the front side toward the rear side, and the escape prevention part 162c protruding from the upper side of the inclined surface of the support part 162b toward the rear side. The surface of the rotating latch 163 contacting the fork load 162 may have the same shape as the surface of the fork load 162.

The trip part 170 is arranged under the rear end of the power transfer part 160. When current over a certain amount is supplied to the inside of the trip part 170, the trip part 170 presses the power transfer part 160 upward, and thus the movable contact 150 contacting the fixed contact 140 pivots in one direction.

Accordingly, when short-circuit or overcurrent over a certain amount is supplied to the trip part 170, the trip part 170 is moved upward. As the trip part 170 moves upward, a part of the rotating latch 163 is pressed upward and pivots in one direction.

Then, the fork load 162 contacting the rotating latch 163 is moved in one direction by the fourth elastic member 166, and thus the catch protrusion 163a supported on the hook 162a of the fork load 162 escapes from the hook 162a. Then, the movable contact 150 pivots in one direction by the electron repulsion force and the restoration force of the first elastic member 151 and is released from the fixed contact 140, and thus the circuit breaker 100 is in a TRIP state.

As described above, according to the present disclosure, when short-circuit or overcurrent occurs, the movable contact is rapidly released from the fixed contact by separating the fork load and the rotating latch, thereby reducing the interruption time.

Furthermore, unlike the conventional technology, since a separate coupling member to fix the rotating latch to the fixed contact is not needed, the assembly time may be reduced.

The present disclosure described above may be variously substituted, altered, and modified by those skilled in the art to which the present inventive concept pertains without departing from the scope and sprit of the present disclosure. Therefore, the present disclosure is not limited to the above-mentioned exemplary embodiments and the accompanying drawings.

What is claimed is:

1. A circuit breaker performing a trip operation when short-circuit or overcurrent occurs, the circuit breaker comprising,
a case having an accommodation space inside;
an upper busbar and a lower busbar partially accommodated in an upper portion and a lower portion of the case, respectively;
a fixed contact provided in the case and connected to the upper busbar;
a movable contact hinge-coupled to the lower busbar and fixed to the case via a first elastic member capable of pivoting in one direction, wherein the movable contact performs a trip operation by being released from the fixed contact;
a power transfer part connected to one side of the movable contact to cross each other, and transferring a rotation force to the movable contact; and
a trip part arranged under a rear end of the power transfer part and pressing the power transfer part upward when current over a certain amount is applied to the inside.

2. The circuit breaker of claim 1, wherein the trip part comprises:
a movable core arranged under the rear end of the power transfer part and pressing the power transfer part; and
a spring pusher applying a compression force to the movable core downward to prevent the movable core from moving upward and pressing the power transfer part upward when current supplied to the inside is less than a preset current value.

3. The circuit breaker of claim 1, wherein, in the movable contact, a portion connected to the first elastic member is located above a portion hinge-coupled to the lower busbar.

4. The circuit breaker of claim 1, wherein the power transfer part comprises:
an input load partially accommodated in the case;
a fork load, which is arranged to cross the movable contact, having a front end hinge-coupled to the input load capable of pivoting in one direction and a hook formed in a lower portion of the fork load; and
a rotating latch, which has an end portion of one side coupled to the movable contact, having one front side connected to the fork load via a second elastic member and a catch protrusion formed in an upper portion of the rotating latch to be caught and supported by the hook.

5. The circuit breaker of claim 1, wherein the power transfer part comprises:
an input load partially accommodated in the case;
a fork load, which is arranged to cross the movable contact, capable of moving back and forth from the input load and having a hook formed in a lower portion of the fork load; and
a rotating latch, which has an end portion of one side coupled to the movable contact, connected to one rear side of the movable contact via a third elastic member and a catch protrusion formed in an upper portion of the rotating latch to be caught and supported by the hook.

6. The circuit breaker of claim 4, wherein the fork load comprises:
a support part, in which a surface contacting the rotating latch is inclined from a front side toward a rear side; and
an escape prevention part protruding from an upper side of an inclined surface of the support part toward the rear side.

7. The circuit breaker of claim 5, wherein the fork load comprises:
a support part, in which a surface contacting the rotating latch is inclined from a front side toward a rear side; and
an escape prevention part protruding from an upper side of an inclined surface of the support part toward the rear side.

8. The circuit breaker of claim 5, further comprising:
a fourth elastic member having a front end and a rear end respectively connected to the input load and the fork load, and arranged in the horizontal direction.
